(19) United States
(12) Patent Application Publication
(10) Pub. No.: US 2003/0189603 A1
(43) Pub. Date: Oct. 9, 2003

(54) Assignment and use of confidence levels for recognized text

(75) Inventors: Manish Goyal, Redmond, WA (US); Ahmad Abdulkader, Redmond, WA (US); Marieke Iwema, Seattle, WA (US); Charlton E. Lui, Redmond, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(73) Assignee: Microsoft Corporation, Redmond, WA (US)

(21) Appl. No.: 10/120,153

(22) Filed: Apr. 9, 2002

(51) Int. Cl. G09G 5/00

(52) U.S. Cl. 345/863

(57) ABSTRACT

A system and method for organizing and prioritizing recognized text. More particularly, a method and system for categorizing recognized text according to confidence levels in the correctness of the recognized text. The system and method may categorize recognized text into two or more different confidence levels. A user interface can display recognized text based upon the confidence level assigned to that text, thereby drawing a user's attention to that text for which the recognition process has a low confidence in its correctness estimate. The user interface may also allow a user to correct erroneously recognized text with different techniques, according to the level of confidence that the recognition process has in the correctness of the text.

### FIELD OF THE INVENTION

The present invention relates to a method and system for allowing a computer to more accurately reject text that has been incorrectly recognized from input data, such as handwriting or speech. The invention also relates to a system that assigns a confidence level for the accuracy of text that has been recognized from input data. A user interface according to the invention can then display recognized text based upon its assigned confidence level. Further, the interface can provide a user with different methods of correcting recognized text based upon the confidence level assigned to the recognized text.

### BACKGROUND OF THE INVENTION

Traditionally, users have employed keyboards to input text directly into computers. As computers have become more powerful and sophisticated, however, users have required that they accept other types of input data. For example, some computers now allow a user to input data by scanning characters printed on paper. The computer will then recognize the characters to produce corresponding text. Some computers alternately, or additionally, permit a user to input data as handwriting, or as speech. The computer will then recognize the handwriting or speech to produce corresponding text. These alternate input techniques advantageously give the user the freedom to input data in the most convenient manner. A user may thus flexibly use a combination of dictation or handwriting as input methods.

Because these alternate input techniques require that the original input data be converted into text, however, inaccuracies in the recognition process may produce erroneous text that does not match the input data. To ensure that the computer has accurately recognized the input data, a user must proofread the recognized text very carefully. This is time consuming, and significantly detracts from the speed and convenience offered by these alternate input techniques. Moreover, even careful proofreading may still not catch every error. For example, the words “dog and clog” both sound and look alike. A handwriting recognition system may therefore erroneously create the text “dog” for the handwritten word “clog.” In a lengthy document, a user proofreading the text might overlook the transposition of the letter “d” for the letters “cl.” Many computer users would therefore benefit from an input data recognition system that reduces the user's proofreading and correction burden.

### SUMMARY OF THE INVENTION

Advantageously, the invention provides a system and method for organizing and prioritizing recognized text. More particularly, the invention offers a method and system for categorizing recognized text according to confidence levels estimated for the correctness of the recognized text. The invention further offers a user interface that displays recognized text based upon the confidence level assigned to that text. For example, text for which the recognition process has a low confidence level is displayed in a different manner than text with a high confidence level. Thus, the user's attention is drawn to that text for which the recognition process has estimated a low confidence in the correctness of its accuracy. A user can then focus his or her proofreading attention on that text with a low level of confidence in its correctness. The user interface may categorize recognized text into two or more different confidence levels (for example, high, medium and low). The recognized text for each confidence level will then be displayed differently to the user.

The user interface may additionally (or alternately) allow a user to correct erroneously recognized text based upon the confidence level assigned to that text. The interface can thus be configured to offer the user the most convenient and appropriate method for correcting erroneously recognized text. For example, with recognized text having a high confidence level, it is very likely that, even if the recognized text is incorrect, the correct text was still identified by the recognition process (such as in a list of the ten most probable words). If the user wants to correct text with a high confidence level, the user interface can save the user the trouble of reentering the correct text by providing, for example, a drop down menu with the alternate text identified by the recognition process. The user can then select the correct text from the menu. On the other hand, with recognized text having a low confidence level, it is very likely that the recognition process did not identify the correct text as an alternate. The user interface can then save the user the effort of hunting through a drop down menu of alternate text, and may instead prompt the user to reenter the erroneously recognized text in its entirety.

Accordingly, by categorizing recognized text into different confidence levels based upon the estimated correctness of the recognized text, the invention can significantly reduce the burden on a user for proofreading recognized text. Instead, the user's attention will be immediately drawn to that text that require the user's attention, and the user can be relatively confident that the remaining text, with a high confidence level, is accurate. Moreover, once the user notes erroneously recognized text, the invention allows the user to correct the text in the most efficient manner. For text having a low confidence level that will probably need to be resubmitted, the user interface can immediately prompt the user to resubmit the text, without having to review a menu of alternate text. On the other, for text with a higher confidence level, the user interface can provide the user with a list of alternate text choices that will most likely contain the correct text.

### BRIEF DESCRIPTION OF THE DRAWINGS

The aspects and features of the invention will be more fully understood when read in conjunction with the accompanying drawings, which are included by way of example, and not by way of limitation with regard to the claimed invention.

FIG. 1 illustrates an exemplary programmable computer, on which various embodiments of the invention may be implemented.

FIG. 2 illustrates a system for displaying recognized text based upon confidence levels in the estimated correctness of the recognized text.

FIG. 3 shows a method for assigning confidence levels to recognized text.

FIG. 4 shows a conventional user interface for displaying recognized text without distinguishing the recognized text based upon confidence levels.

FIGS. 5A-5D illustrate user interfaces for displaying and correcting recognized text based upon confidence levels in the correctness of the recognized text.

### DETAILED DESCRIPTION OF EMBODIMENTS OF THE INVENTION

The invention may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

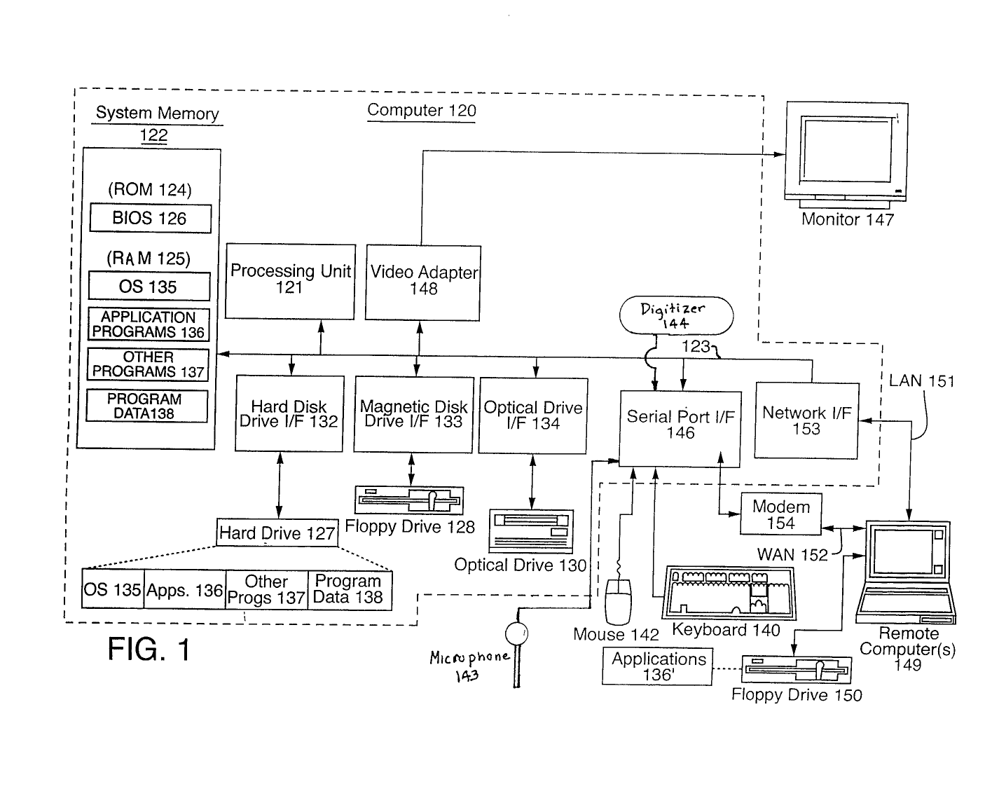

As noted above, the invention relates to the display and correction of text recognized from input data to a computer. Accordingly, it may be helpful to briefly discuss the components and operation of a typical programmable computer on which various embodiments of the invention may be implemented. Such an exemplary computer system is illustrated in FIG. 1. The system includes a general purpose computing device 120. This computing device may take the form of a conventional personal digital assistant, a tablet, desktop or laptop personal computer, network server or the like.

Computing device 120 typically includes at least some form of computer readable media. Computer readable media can be any available media that can be accessed by the computing device 120. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by the computing device 120. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The computing device 120 will typically include a processing unit 121, a system memory 122, and a system bus 123 that couples various system components including the system memory 122 to the processing unit 121. The system bus 123 may be any of several types of bus structures including a memory bus or memory controller, a peripheral bus, and a local bus using any of a variety of bus architectures. The system memory includes computer storage media devices, such as a read-only memory (ROM) 124 and random access memory (RAM) 125. A basic input/output system 126 (BIOS), containing the basic routines that help to transfer information between elements within the personal computer 120, such as during startup, is stored in ROM 124.

The personal computer or network server 120 may further include additional computer storage media devices, such as a hard disk drive 127 for reading from and writing to a hard disk (not shown), a magnetic disk drive 128 for reading from or writing to a removable magnetic disk 129, and an optical disk drive 130 for reading from or writing to a removable optical disk (not shown) such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide non-volatile storage of computer readable instructions, data structures, program modules and other data for the personal computer or network server 120.

Although the exemplary environment described herein employs a hard disk drive 127, a removable magnetic disk drive 128 and a removable optical disk drive 130, it should be appreciated by those skilled in the art that other types of computer readable media which can store data that is accessible by a computer, such as magnetic cassettes, flash memory cards, digital video disks, Bernoulli cartridges, random access memories (RAMs), readonly memories (ROMs) and the like may also be used in the exemplary operating environment. Also, it should be appreciated that more portable embodiments of the computing device 120, such as a tablet personal computer or personal digital assistant, may omit one or more of the computer storage media devices discussed above.

A number of program modules may be stored on the hard disk drive 127, magnetic disk drive 128, optical disk drive 130, ROM 124 or RAM 125, including an operating system 135 (e.g., the Windows CE, Windows® 2000, Windows NT®, or Windows 95/98 operating system), one or more application programs 136 (e.g. Word, Access, Pocket PC, Pocket Outlook, etc.), other program modules 137 and program data 138. A user may enter commands and information into the computing device 120 through input devices such as a keyboard 140 and pointing device 142.

As previously noted, the invention is directed to providing a confidence level in the correctness of text that has not been entered into the computing device 120 using a keyboard. Accordingly, the computing device 120 will also include one or more additional input devices, other than keyboard 140, through which text information may be submitted. These other input devices may include, for example, a microphone 143, into which a user can speak input data, and a digitizer 144, through which a user can input data by writing the input data onto the digitizer 144 with a stylus. As will be appreciated by those of ordinary skill in the art, the digitizer 144 may be an individual standalone device. Alternately, as with a personal digital assistant or a tablet personal computer, it may be integrated into a display for the computing device 120. Still other input devices may include, e.g., a joystick, game pad, satellite disk, scanner, touch pad, touch screen, or the like.

These and other input devices are often connected to the processing unit 121 through a serial port interface 146 that is coupled to the system bus 123, but may be connected by other interfaces, such as a parallel port, game port, universal serial bus (USB), or a 1394 high-speed serial port. A monitor 147 or other type of display device is also connected to the system bus 123 via an interface, such as a video adapter 148. In addition to the monitor 147, personal computers typically include other peripheral output devices (not shown), such as speakers and printers.

The computing device 120 may operate in a networked environment using logical connections to one or more remote computers, such as a remote computing device 149. The remote computing device 149 may be another personal digital assistant, personal computer or network server, a router, a network PC, a peer device or other common network node, and typically includes many or all of the elements described above relative to the computing device 120, although only a memory storage device 150 has been illustrated in FIG. 1. The logical connections depicted in FIG. 1 include a local area network (LAN) 151 and a wide area network (WAN) 152. Such networking environments are commonplace in offices, enterprise-wide computer networks, Intranets and the Internet.

When used in a LAN networking environment, the computing device 120 is connected to the local network 151 through a network interface or adapter 153. When used in a WAN networking environment, the personal digital assistant, personal computer or network server 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the computing device 120, or portions thereof, may be stored in the remote memory storage device 150. It will be appreciated that the network connections shown are exemplary and other means of establishing a communications link between the computers may be used.

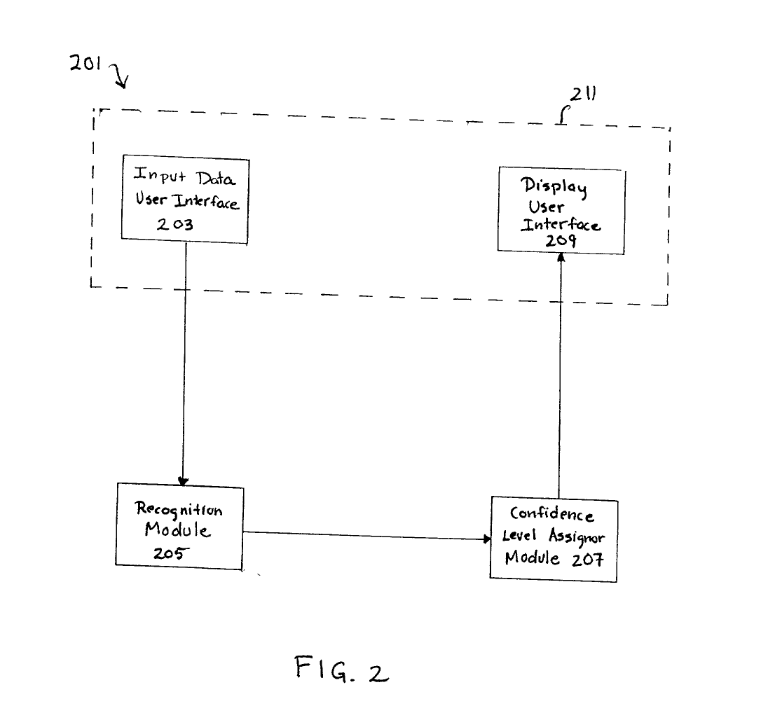

FIG. 2 provides a block diagram illustrating the components of an input data recognition system 201 according to one exemplary embodiment of the invention. The recognition system 201 includes an input data user interface 203, a recognition module 205, a confidence level assignor module 207, and a display and correction user interface 209 (hereafter referred to simply as the display user interface 209). As shown in this figure, the input data interface 203 and the display user interface 209 may be two components of a single user interface 211. It should be noted, however, that the input data user interface 203 and the display user interface 209 may alternately be separate and independent user interfaces.

The input data user interface 203 receives input data from the user in a form other than text from the keyboard 140. For example, the input data user interface 203 may receive input data as speech received through the microphone 143, or it may receive input data as handwriting written onto the digitizer 144 with a stylus or pen. Still further, the input data user interface 203 may receive input data scanned from alphanumeric characters printed onto paper or other medium.

After receiving the input data, the input data user interface 203 provides the input data to the recognition module 205, which recognizes the input data. More particularly, the recognition module 205 takes input data and generates text corresponding to the input data. It should be noted that the recognition module 205 will be appropriate to the type of input data allowed by the input data user interface 203. If the user writes words in handwriting onto the digitizer 144, then the recognition module 205 will analyze the handwriting to determine which text best matches the handwriting. Similarly, if the user speaks the input data aloud into the microphone 143, then the recognition module 205 will determine which text best matches the spoken sounds.

It should also be noted that the recognition module 205 may include and employ multiple different recognition subsystems, each using its own combination of one or more handwriting algorithms, and each having its unique strengths and weaknesses. The recognition module 205 may therefore employ two or more of these different handwriting recognition subsystems for handwriting recognition, in order to improve the overall accuracy of the recognition module 205. A variety of recognition algorithms that may be employed by these recognition sub-systems for recognizing text from different data input types are well known in the art, and thus will not be described in detail here.

As will be appreciated by those of ordinary skill in the art, conventional recognition algorithms (or combinations of algorithms) recognize text according to a “score” that is generated by comparing or contrasting an input object to one or more reference objects in a recognition dictionary. For example, with handwriting recognition algorithms, the algorithm will compare or contrast selected characteristics of an input object with the characteristics of each letter object in a recognition dictionary. Thus, if a user writes the letter “a”, the algorithm will compare the characteristics of that handwritten letter with the characteristics of a reference object for the letter “a,” the characteristics of a reference object for the letter “b,” the characteristics of a reference object for the letter “c,” the characteristics of a reference object for the letter “d,” and so on for each character in the recognition dictionary. Similarly, if the user speaks a sound, a speech recognition algorithm compares that sound's characteristics, such as volume, pitch, length and tremor, with each phoneme stored in the recognition dictionary.

Based upon the differences or similarities between the input object and that reference object, the recognition algorithm generates a score for each reference object in the recognition dictionary and then recognizes the input object using those scores. For example, if the user handwrites the letter “a,” the recognition algorithm will compare the characteristics of that handwritten letter with the characteristics of the reference objects for the letters “a,” “b,” and “c.” Based upon the comparisons, the algorithm may return a score of “10” for the comparison with the reference object for the letter “a,” a score of “20” for the comparison with the reference object for the letter “b,” and a score of “35”for the comparison with the reference object for the letter “c.” From this, the recognizer will recognize the handwritten text as the letter “a.” If the letter is written somewhat differently, however, the recognition algorithm may return a score “1000” for the comparison with the reference object for the letter “a,” a score of “1050” for the comparison with the reference object for the letter “b,” and a score of “2000” for the comparison with the reference object for the letter “c.” Thus, these scores may vary widely depending upon the input object, and an absolute score value cannot be used to determine a confidence in the correctness of a recognized letter.

In addition to generating a score for individual letters or phonemes, many recognition processes will also generate scores for a group of letters or phonemes to recognize words or even phrases as a whole. That is, the recognizer may compare the group of recognized letters or sounds with one or more words or phrases in a recognition dictionary, and then generate a score for each comparison in order to recognize the characters or sounds as a single word or phrase. For example, the word “Mississippi” is one of the few words in the English language that includes three “i's.” Thus, even if the letter “M” in this word is poorly written and improperly recognized as an “N” by a handwriting algorithm, when the entire group of letters in the word is compared with the recognition dictionary reference for “Mississippi” the proper recognition of the three “i's” in the word may still generate a score that will lead the recognizer to correctly recognize the word as “Mississippi” over alternate words in the recognition dictionary.

The confidence level assignor module 207 employs this score information provided by the recognition algorithm sub-systems to estimate a correctness of the recognized text, and then to determine a confidence level for the estimated correctness of each word of recognized text. With some embodiments of the invention, the confidence level assignor module 207 assigns each word of recognized text one of two possible confidence levels. If the confidence level assignor module 207 determines that the recognition of the text is very likely to be correct, the confidence level assignor module 207 will assign that text a high confidence level. All other recognized text will then be assigned a low confidence level. Alternately, the confidence level assignor module 207 may categorize each recognized word into three or more different confidence levels (for example, a high confidence level, a medium confidence level, and a low confidence level), depending upon the estimated recognition correctness of the word.

The display interface 209 then displays recognized text according to the confidence level that has been assigned to that text. Thus, recognized text with a high confidence level may be displayed with a regular font. This allows a user to quickly read through this text, without studying it in detail, or even to ignore it altogether. Recognized text with a medium confidence level can then be displayed with highlighting, coloring, underlining or some other indication that will draw the user's attention to this text. This allows a user to quickly identify and correct the text that is more likely to be incorrect.

Still further, the display user interface 209 may use an even more extreme indicator to display recognized text having a low user confidence. For example, if the original input data was handwriting, the display user interface 209 may not show recognized text corresponding to the handwriting, but instead show an image of the original handwriting input. This conveniently allows a user to identify the correct text from the original handwriting input. Alternately, if the original input data was speech, the display user interface 209 may provide a command button or icon that, when activated by the user, audibly repeats the original input data corresponding to selected low confidence text, so that the user can easily identify the correct text.

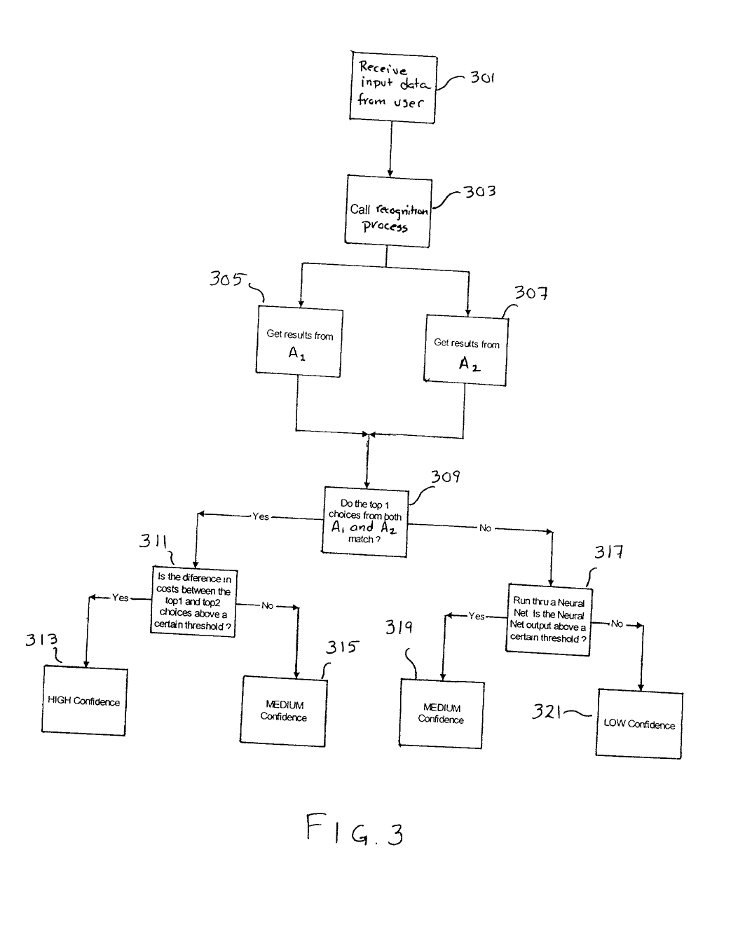

One method for assigning a confidence level based upon the correctness estimate of recognized text is shown in FIG. 3. In step 301, the input data user interface 203 receives the input data from the user, and, in step 303, initiates the recognition module 205 necessary to recognize the input data. In the illustrated embodiment, the input data is handwriting, so the recognition module 205 employs handwriting recognition algorithms to match the input data to words of text. Those of ordinary skill in the art, however, will appreciate that this method may also be adapted for use with other types of input data, such as speech and printed character input data.

As shown in the figure, the recognition module 205 of this embodiment employs two separate recognition algorithm sub-systems A₁ and A₂, and the recognition results of these algorithm sub-systems are obtained in steps 305 and 307, respectively. In this embodiment, the recognition results include a list of text choices most closely matching the input data, and the corresponding recognition score for each text choice in the list. It should be noted, however, that with other embodiments of the invention, the results may include additional or alternate information useful in determining the accuracy of the recognized text.

It should also be noted that other embodiments of the invention may use only one recognition algorithm sub-system, or may employ three or more algorithm sub-systems as desirable to improve the recognition accuracy of the recognition module 205. As will be appreciated by those of ordinary skill in the art, different recognition algorithm sub-systems offer different degrees of accuracy. Moreover, the more independent the different algorithms employed by each algorithm sub-system are (that is, the more distinct the considerations made by different algorithms), the more likely it is that one of the algorithm sub-systems will correctly recognize the input data. Thus, if two or more different recognition algorithm sub-systems agree upon the same text as matching the input data, then that text is extremely likely to be correct. Accordingly, in step 309, the confidence level assignor module 207 compares the first text choice from the results of algorithm A₁ with the first text choice from the results of algorithm A₂. If these choices match, the method proceeds to step 311. If they do not match, then the method proceeds to step 317.

As previously noted, different recognition algorithms will provide differing degrees of accuracy. In the illustrated embodiment, for example, the algorithms used by the algorithm sub-system A₁ are typically more accurate than those of the algorithm sub-system A₂. In step 311, the confidence level assignor module 207 therefore calculates the difference between the recognition score for the first text choice provided by the algorithm sub-system A₁ and the recognition score for the second text choice of the algorithm sub-system A₁. When the scores of the top two choices are very close, the algorithm sub-system A₁ has not been able to clearly distinguish between the two choices. For example, the recognition scores obtained by comparing written text to the words “dog” and “clog” may be relatively close. In this situation, the correctness of the first choice over the second choice is not certain.

On the other hand, if the recognition scores for the top two choices are relatively different, then the algorithm sub-system A₁ has established a clear preference for the top choice, suggesting that this choice is most probably correct. Thus, if difference between the recognition score for the first and second choices of the algorithm sub-system A₁ is above a first threshold value, then the confidence level assignor module 207 assigns the first text choice (already selected as the recognized text) a confidence level of “high” in step 313. On the other hand, if the difference is equal to or below the first threshold value, then the confidence level assignor module 207 assigns the first text choice (still selected as the recognized text) a confidence level of “medium” in step 315.

It should be noted that additional processing may be needed to obtain the difference between accuracy estimates in step 311. For example, the handwriting recognition algorithm sub-system A₁ may calculate a recognition score for each handwritten character, rather than upon an entire word as a whole. In this instance, the recognition scores for text choices of different lengths may be normalized before their difference is obtained. Also, it should be noted that, if the accuracy of the algorithm sub-system A₁ is approximately the same as the accuracy of the algorithm sub-system A₂, then the procedure of step 311 may take into account accuracy estimates for both recognition algorithm sub-systems.

Returning now to step 317, if the first text choice from the results of algorithm sub-system A₁ does not match the first text choice from the results of algorithm sub-system A₂, then the confidence level assignor module 207 processes the recognition scores for both the top choices through a neural network in order to select a single choice as the recognized text. As known in the art, a neural network may be configured to employ a set of weighted functions corresponding to the various strengths and weaknesses of each algorithm sub-system. Thus, the neural network may be trained to provide a high value whenever a recognized word matches the handwritten input. If the output from the neural net calculation for the selected text choice is above a second threshold, then the confidence level assignor module 207 assigns this text a confidence level of “medium” in step 319. If, on the other hand, the output from the neural net calculation for the selected text choice is equal to or below the second threshold value, then the confidence level assignor module 207 assigns the winning result a threshold level of “low” in step 321.

It should be noted from the foregoing explanation that, in addition to assigning a confidence level to each recognized text choice, the invention also combines the results of two or more different recognition algorithms to determine a rejection rate (the percentage of text choices assigned a confidence level of “low”) for the recognition module 205. Thus, the invention rejects recognized text only if the accuracy estimates of each recognition algorithm are relatively equivalent when the overall accuracy of each algorithm is considered. Of course, those of ordinary skill in the art will appreciate that this technique for determining the recognition rejection rate can be similarly employed where the recognition module 205 uses any number of different recognition algorithms.

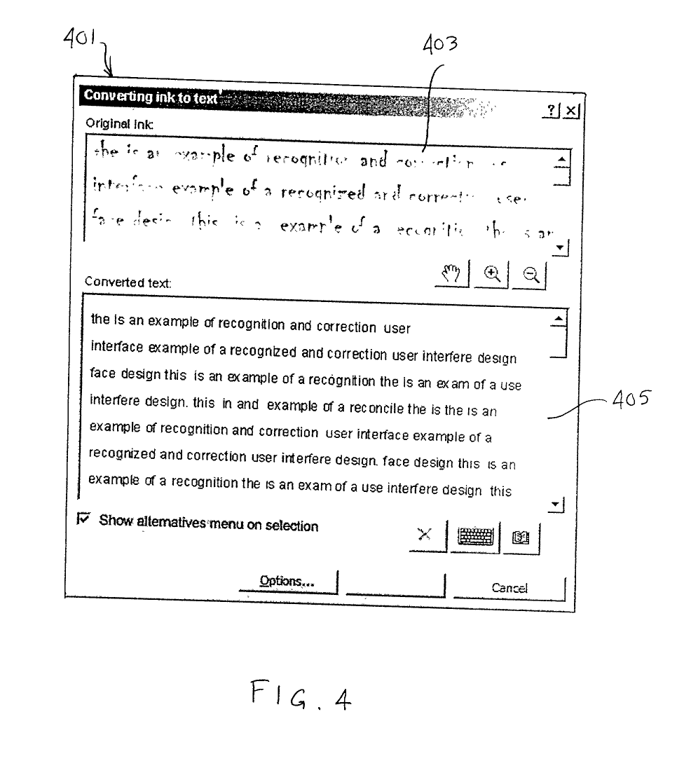

As described above, once confidence levels have been assigned to each choice of recognized text, the display and correction user interface 209 displays each choice of recognized text according to its assigned confidence level. To better appreciate this feature, FIG. 4 illustrates a conventional display user interface 401. That is, the user interface 401 displays recognized text without distinguishing between recognized text choices having different confidence levels. This display user interface 401 includes an input data display portion 403 and a recognized text display portion 405. The input data display portion 403 displays the original input data that, in this example, is handwriting input. The recognized text display portion 405 then displays text that has been recognized from the input data. As seen in this figure, all of the recognized text is displayed using the same font in a conventional, homogenous manner. A user must therefore carefully proofread the recognized text in the recognized text display portion 405 to ensure that it does not have any errors.

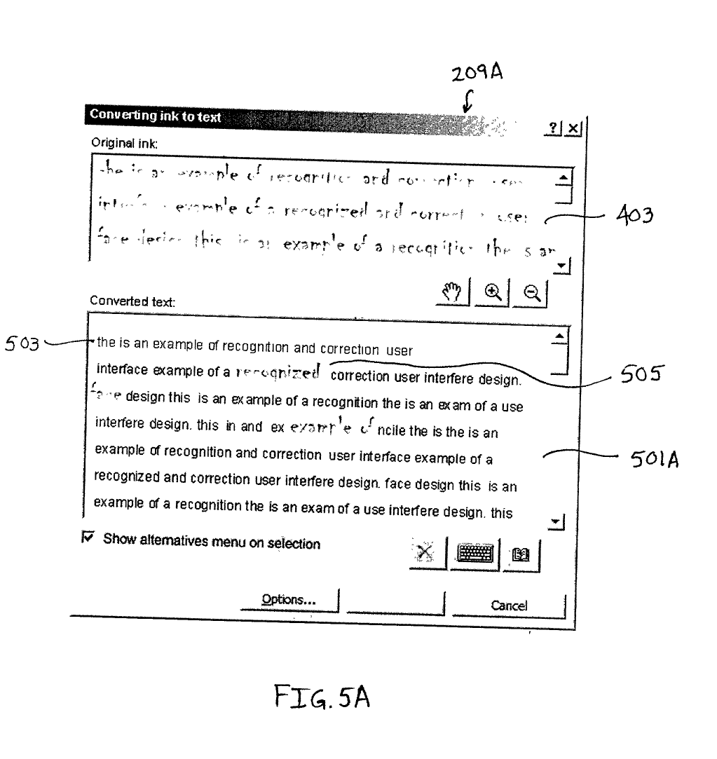

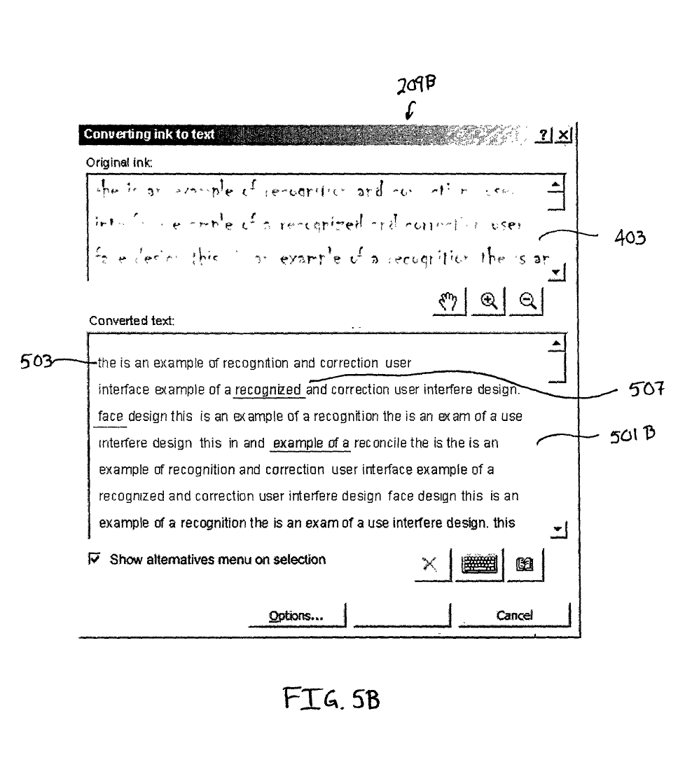

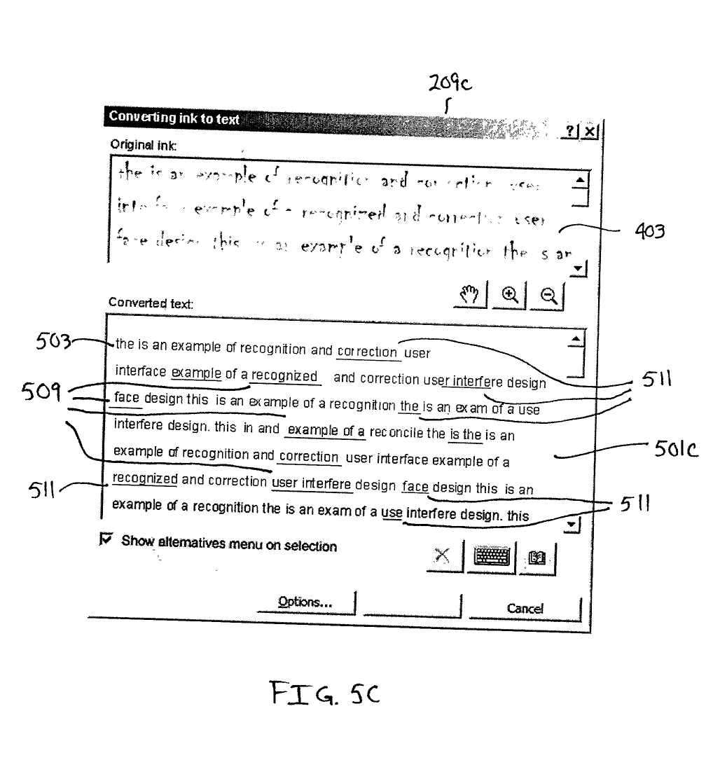

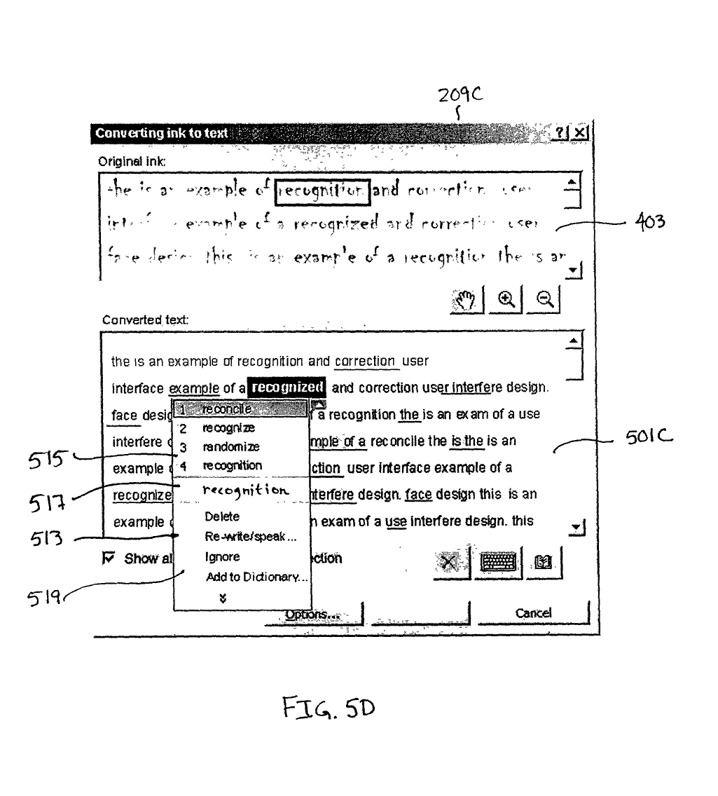

FIGS. 5A and 5B illustrate two display user interfaces 209A and 209B, respectively, which display corrected text when the confidence level assignor module 207 has assigned the corrected text one of two different confidence levels. With these embodiments, the confidence level assignor module 207 may assign most of the recognized text a high confidence level, while only that text with a very small estimate of correctness will be assigned a low confidence level. Like the display user interface 401, the display user interfaces 209A and 209B each include an input display portion 403 and a recognized text display portion 501. With the display user interfaces 209A and 209B, however, the recognized text display portion 501 displays recognized text with a low confidence level in a different way than recognized text with a high confidence level.

Turning now to FIG. 5A, for example, the first line of recognized text 503 has been assigned a high confidence level, and is displayed using alphanumeric characters in a regular font. In the second line of recognized text, however, the text choice for the handwritten input data word “recognized” has been assigned a low confidence level. Accordingly, rather than display the text choice for this input data, the recognized text display portion 501A instead displays the image of the original handwritten input data 505. Because the original handwriting input data is displayed instead of recognized text with a low confidence level, a user can readily identify the input data that probably needs to be resubmitted. Moreover, by displaying the original handwriting input data, the user can quickly determine the incorrectly recognized word or letters.

In addition to displaying recognized text with different confidence levels in a different manner, the display user interface 209A may conveniently allow a user to correct recognized text of different confidence levels with different techniques. For example, if recognized text having a high confidence level is incorrect, then the alternate text choices produced by the recognition algorithm or algorithms will probably include the correct text. Accordingly, the display user interface 209A may allow the user to correct recognized text with a high confidence level by providing a list of the alternate text choices in a drop down menu. The user can then simply select the correct text choice from the menu. On the other hand, if recognized text having a low confidence level is incorrect, then the alternate text choices produced by the recognition algorithm or algorithms probably do not include the correct text either. Accordingly, rather than force the user to review a list of alternate text choices that most likely do not contain the correct text choice, the display user interface 209A may instead directly prompt the user to reenter the unrecognized input data.

The display user interface 209B in FIG. 5B is similar to the display user interface 209A, except that the recognized text display portion 501B displays recognized text having a low confidence level with a combination of highlighting and underlining in red, rather than with the image of the original input data. Thus, in FIG. 5B, the text choice for the input data word “recognized” is displayed as the text “recognized” 507, with the font for the text highlighted and underlined. With this arrangement, if recognized text with a low confidence level is nonetheless accurate, the user can validate the recognized text without having to resubmit its corresponding input data (for example, without having to rewrite the word on the digitizer 144). Further, the user can correct any of the text in the recognized text display portion 501B by, for example, activating the text to display a drop down menu with alternate text choices, and selecting the correct text choice from the menu (or, alternately, resubmitting the input data if the correct text choice is not included on the drop down menu). Of course, those of ordinary skill in the art will appreciate that text with a low confidence level may be indicated using any desired combination of techniques, including underlining, highlighting, bold, and coloring.

By displaying recognized text with a low confidence level differently than recognized text with a high confidence level, the display user interfaces 209A and 209B allow the user to quickly identify the text that will most likely need correction. Moreover, these display user interfaces 209A and 209B may allow the user to correct the recognized text more quickly than a display user interface that does not distinguish between recognized text based upon confidence levels. Even with these interfaces, however, the user must still carefully proofread the recognized text having a high confidence level, as this text will probably contain some errors.

FIG. 5C illustrates a display user interface 209C which displays corrected text where the confidence level assignor module 207 has assigned the corrected text one of three confidence levels: high, medium, or low. One technique for categorizing recognized text into one of these three groups was discussed above with reference to FIG. 3. As with the display user interface 209B, the display user interface 209C displays recognized text having a high confidence level with characters in a regular font. It also displays recognized text 509 having a low confidence level with characters that are highlighted and underlined in red. Unlike display user interface 209B, however, the display user interface 209C identifies text 511 having a medium confidence level with characters that are underlined in red, but not highlighted.

By displaying three distinct confidence levels of recognized text differently, the display user interface 209C reduces the burden on the user to proofread and correct the recognized text. By identifying the recognized text with a low confidence level, the display user interface 209C immediately alerts the user to the text that the user will probably need to correct. Also, by identifying the recognized text with a medium confidence level, the display user interface 209C apprises the user of that text the user may need to correct, but which also can be easily corrected by selecting an alternate text choice from, for example, a drop down menu or other listing of alternate text choices. Thus, while a user may still choose to proofread the recognized text in its entirety, the display user interface 209C alerts the user to the recognized text that will require more attention.

One possible technique for correcting erroneously recognized text with the display user interface 209C is shown in FIG. 5D. A user first selects the recognized text to be corrected by, for example, moving a pointer, such as cursor, to the erroneously recognized text and then activating a selection button (sometimes referred to as “clicking” on the text). As seen in FIG. 5D, when recognized text is selected, the display user interface 209C produces a drop down menu 513. The drop down menu 513 includes an alternate list portion 515, a text portion 517, and a command portion 519. The alternate list portion 515 includes a list of the next most likely correct text choices selected by the recognition module 205. If the correct text is included in the list portion 515, the user can correct the erroneously recognized text by selecting the correct alternate text choice from the list portion 515.

If the user is uncertain as to what the correctly recognized text should be, the user may view the text portion 517. This displays the original input data (for example, the original handwriting input), so that the user can determine the correctly recognized text. This feature is particularly useful where the interface 209C omits the input display portion 403. The command portion 519 then allows the user to issue various commands for editing the selected text. For example, as shown in the figure, if the selected recognized text is incorrect, a user may delete the text, or summon another user interface to rewrite (or respeak, if appropriate) the text. If the selected recognized text is actually correct, the user may have the display user interface 209C ignore the text (that is, treat it as recognized text with a high confidence level), or add the recognized text to the dictionary of the recognition module 205. Of course, additional or alternate commands may be included the command portion 519.

As will be appreciated by those of ordinary skill in the art, there are a number of variations of the invention that may be desirable, depending upon the particular application of the invention. For example, while FIG. 3 describes one particular technique for categorizing recognized text into one of three different confidence levels, any number of alternate techniques can be used to assign confidence levels to recognized text. Moreover, while techniques for categorizing recognized text into two or three different confidence levels have been discussed above, the confidence level assignor module 207 can be configured to classify recognized text into four, five, or any number of different confidence levels. Of course, those of ordinary skill in the art will appreciate that different confidence levels may be indicated using any desired combination of techniques, including, but not limited to, underlining, highlighting, bold, and coloring.

Those of ordinary skill in the art will also appreciate that it may be desirable to give the user the ability to determine how the confidence level assignor module 207 assigns a confidence level to recognized text. Thus, for important documents, a user may want to have a very high standard for assigning recognized text a high confidence level. On the other hand, for draft documents, where accuracy may be sacrificed for speed, a user may want the display user interface 209 to identify only the most egregious incorrectly recognized text. Various embodiments of the invention may therefore allow a user to control the assignment of confidence levels to recognized text.

For example, with the confidence level assignment technique described above with reference to FIG. 3, the confidence level assignor module 207 determines whether recognized text is assigned a high confidence level or a medium confidence level according to the first threshold employed in step 311. Variations of the invention may therefore allow a user to change this first threshold, in order to raise or lower the requirements for assigning recognized text a high confidence level. Similarly, the confidence level assignor module 207 determines whether recognized text is assigned a medium confidence level or a low confidence level according to the second threshold employed in step 317. Various embodiments of the invention may therefore allow a user to alternately, or additionally, change this second threshold, in order to raise or lower the requirements for assigning recognized text a low confidence level. Of course, still other variations of the invention will be apparent to those of ordinary skill in the art, and are to be encompassed by the subsequent claims.

Although the invention has been defined using the appended claims, these claims are exemplary in that the invention may be intended to include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention. It may be intended that the written description of the invention contained herein covers all such modifications and alterations. For instance, in various embodiments, a certain order to the data has been shown. However, any reordering of the data is encompassed by the present invention. Also, where certain units of properties such as size (e.g., in bytes or bits) are used, any other units are also envisioned.

What is claimed is:

1. A method for displaying text that has been recognized from input data, comprising:
determining a confidence level in the correctness of the text; and
displaying the text according to the confidence level determined for the text.

2. The method for displaying text recited in claim 1, further comprising:
correcting recognized text according to the confidence level determined for the text.

3. The method for displaying text recited in claim 2, further comprising:
correcting recognized text by providing a menu with a list of alternate text choices.

4. The method for displaying text recited in claim 2, further comprising:
correcting recognized text by prompting a user to resubmit input data corresponding to the recognized text.

5. The method for displaying text recited in claim 1, further comprising:
determining whether the correctness of the text has a high level of confidence or a low level of confidence.

6. The method for displaying text recited in claim 1, further comprising:
determining whether the correctness of the text has a confidence level selected from the group of: a high level of confidence, a medium level of confidence, and a low level of confidence.

7. The method for displaying text recited in claim 1, further comprising:
determining whether the correctness of the text has confidence level selected from the group of four or more different confidence levels.

8. The method for displaying text recited in claim 1, further comprising:
displaying the input data.

9. A method for correcting text that has been incorrectly recognized from input data, comprising:
determining a confidence level in a correctness of the text; and
providing a correction process for correcting the text according to the confidence level assigned to the text.

10. The method for correcting text recited in claim 9, further comprising:
providing a first correction process to correct the text if the confidence level is equal to or above a threshold value, and providing a second correction process to correct the text if the confidence level is below the threshold value.

11. The method for correcting text recited in claim 10, further comprising:
correcting recognized text according to the first correction process by providing a menu with a list of alternate text choices.

12. The method for correcting text recited in claim 10, further comprising:
correcting recognized text according to the second correction process by prompting a user to resubmit input data corresponding to the recognized text.

13. The method for correcting text recited in claim 10, further comprising:
providing a third correction process to correct the text if the confidence level is equal to or above a second threshold value.

14. The method for correcting text recited in claim 9, further comprising
determining the confidence level in the correctness of the text from among a group of confidence levels consisting of: a high confidence level, a medium confidence level, and a low confidence level.

15. A method of rejecting text that has been incorrectly recognized from input data, comprising:
employing a plurality of recognition processes to recognize input data as text;
determining, for each recognition process, an estimate for a correctness of the text;
determining a confidence level for the text based upon the correctness estimate; and
rejecting the text if the determined confidence level is below a threshold value.

16. The method of rejecting text recited in claim 15, further comprising:
displaying the rejected text so as to uniquely identify the rejected text.

17. The method of rejecting text recited in claim 15, further comprising:
determining the correctness estimate for the text using a neural network.

18. The method of rejecting text recited in claim 15, wherein each of the recognition processes is independent from the other recognition processes.

19. A user interface for displaying recognized text, comprising:
a recognized text portion for displaying text recognized from input data according to a confidence level for a correctness estimate of the text.

20. The user interface recited in claims 19, further comprising:
displaying text having a correctness estimate with a confidence level equal to or above a threshold value in a first manner, and
displaying text having a correctness estimate with a confidence level below the threshold value is displayed in a second manner.

21. The user interface recited in claim 19, further comprising:
a text correction portion for correcting incorrectly recognized text.

22. The user interface recited in claim 21, wherein the text correction portion includes a menu of alternate text choices.

23. The user interface recited in claim 21, wherein the text correction portion includes a prompt for a user to resubmit input data corresponding to the incorrectly recognized text.

24. The user interface recited in claim 19, further comprising:
an input data display portion for displaying the input data corresponding to the recognized text.

25. A device for recognizing input data as text, comprising:
a text recognition module that recognizes input data as text;
a confidence level assignor module that assigns a confidence level in a correctness of the text recognized from the input data; and
a user interface that displays recognized text for correction according to the confidence level assigned to the recognized text.

26. The device for recognizing input data as text recited in claim 25, further comprising:
a first display portion for displaying text having a correctness with a confidence level equal to or above a threshold value in a first manner, and
a second display portion for displaying text having a correctness with a confidence level below the threshold value in a second manner.

27. The device for recognizing input data as text recited in claim 25, wherein the user interface further includes an input data display portion for displaying input data corresponding to the recognized text.

28. The device for recognizing input data as text recited in claim 25, wherein the user interface further includes a text correction portion for correcting incorrectly recognized text.

29. The device for recognizing input data as text recited in claim 28, wherein the text correction portion includes a menu of alternate text choices.

30. The device for recognizing input data as text recited in claim 28, wherein the text correction portion includes a prompt for a user to resubmit input data corresponding to the incorrectly recognized text.
